(19) United States
(12) Patent Application Publication
(10) Pub. No.: US 2024/0257099 A1
(43) Pub. Date: Aug. 1, 2024

(54) DYNAMICALLY ASSIGNING CARD ACCOUNT PARAMETERS FOR JUST-IN-TIME ELECTRONIC CARD TRANSACTIONS

(71) Applicant: Marqeta, Inc., Oakland, CA (US)

(72) Inventor: Akhila Singaraju, Oakland, CA (US)

(21) Appl. No.: 18/465,665

(22) Filed: Sep. 12, 2023

Related U.S. Application Data
(60) Provisional application No. 63/482,402, filed on Jan. 31, 2023.

(51) Int. Cl. G06Q 20/34; G06Q 20/02; G06Q 20/40; G06Q 30/0207

(52) U.S. Cl. CPC G06Q 20/34; G06Q 20/027; G06Q 20/40; G06Q 30/0215

(57) ABSTRACT

This disclosure describes methods, non-transitory computer readable storage media, and systems that dynamically determine processing parameters for electronic card transactions involving funding sources via external gateways in real-time. Specifically, in response to receiving a transaction authorization request routed to a card processing system from a payment network, the disclosed system sends a funding request to an external gateway that services an external funding source of a payment card account. The disclosed system determines a set of dynamic processing parameters for the electronic card transaction based on characteristics of the transaction and predefined parameter ranges corresponding to the payment card account. Additionally, the disclosed system processes the transaction by funding the transaction from the external funding source according to the dynamic processing parameters. Furthermore, the disclosed system authorizes the electronic card transaction and determine the dynamic processing parameters within a response time deadline corresponding to the transaction authorization request.

### CROSS-REFERENCE TO RELATED APPLICATIONS

This application claims the benefit of and priority to U.S. Provisional Patent Application No. 63/482,402 filed Jan. 31, 2023, entitled DYNAMICALLY ASSIGNING CARD ACCOUNT PARAMETERS FOR JUST-IN-TIME ELECTRONIC CARD TRANSACTIONS, which is incorporated herein by reference in its entirety.

### BACKGROUND

Increases in computing technology and availability have led to an increase in use of card-based payment transactions and electronic payment transactions to complete purchase transactions. The prevalence of card/electronic payment transactions has led to many entities providing increased access to payment cards (e.g., credit cards or debit cards) for consumers to use with merchants and recipient entities. Additionally, in connection with providing access to payment cards to use in card-based payment transactions and electronic payment transactions, such entities are providing more options for funding card-based payment transactions or other parameters of the card-based payment transactions. Increasing the number of options available for card-based transactions, however, also increases the complexity involved with processing such transactions in a timely manner while conforming with communication requirements of different devices and systems involved.

While many entities provide increased access to card-based/electronic payment transactions, conventional systems involved with such transactions lack flexibility and efficiency. Specifically, some conventional systems that provide access to payment card accounts with variability in account parameters or processing parameters have predetermined parameters for any given transaction. Accordingly, such conventional systems lack the ability to dynamically make decisions for processing card-based/electronic payment transactions in real-time. Thus, cardholders and entities communicating with the conventional systems are limited to initiating and processing transactions according to the predetermined parameters.

Furthermore, as mentioned, increasing the number of options available for card-based/electronic payment transactions introduces additional complexity for processing the transactions. Conventional systems typically lack the ability to perform certain operations due to the rigidity of the conventional systems and the communication requirements of various systems/devices for achieving real-time processing. For example, certain operations for involving additional entities (e.g., a third-party funding source) in processing operations for a payment card account take time to process and send/receive electronic communications between devices. Accordingly, the rigidity of the conventional systems prevents the conventional systems from being able to perform such operations in the required amounts of time.

### SUMMARY

This disclosure describes one or more embodiments of methods, non-transitory computer readable media, and systems that solves one or more of the foregoing problems (in addition to providing other benefits). In one or more embodiments, the disclosed systems dynamically determine processing parameters for electronic card transactions involving funding sources via external gateways in real-time. Specifically, in response to receiving a transaction authorization request routed to a card processing system from a payment network, the disclosed systems send a funding request to an external gateway that services an external funding source of a payment card account. The disclosed systems determine a set of dynamic processing parameters for the electronic card transaction based on characteristics of the transaction and predefined parameter ranges corresponding to the payment card account. Additionally, the disclosed systems process the transaction by funding the transaction from the external funding source according to the dynamic processing parameters. Furthermore, in some embodiments, the disclosed systems authorize the electronic card transaction and determine the dynamic processing parameters within a response time deadline corresponding to the transaction authorization request. By determining dynamic processing parameters for an electronic card transaction via an external gateway, the disclosed systems provide flexible and efficient processing of electronic card transactions while providing control over the transaction to an external funding source in real-time.

### BRIEF DESCRIPTION OF THE DRAWINGS

The detailed description refers to the drawings briefly described below.

FIG. 1 illustrates a block diagram of a system environment in which a card processing system is implemented in accordance with one or more implementations.

FIG. 2 illustrates a diagram of an overview of the card processing system determining dynamic processing parameters for an electronic card transaction via an external gateway in real-time in accordance with one or more implementations.

FIGS. 3A-3B illustrate flow diagrams of the card processing system authorizing an electronic card transaction and determining dynamic processing parameters via an external gateway in real-time in accordance with one or more implementations.

FIG. 4 illustrates a flow diagram of the card processing system declining an electronic card transaction via an external gateway in real-time in accordance with one or more implementations.

FIG. 5 illustrates a diagram of the card processing system performing additional transaction operations in connection with an electronic card transaction based on dynamic processing parameters in accordance with one or more implementations.

FIG. 6 illustrates a diagram of the card processing system authorizing and determining dynamic processing parameters via an external gateway according to a response time period associated with a payment network in accordance with one or more implementations.

FIG. 7 illustrates a flowchart of a series of acts for determining dynamic processing parameters for an electronic card transaction via an external gateway in real-time in accordance with one or more implementations.

FIG. 8 illustrates a block diagram of an exemplary computing device in accordance with one or more implementations.

### DETAILED DESCRIPTION

This disclosure describes one or more embodiments of a card processing system that determines dynamic processing parameters via an external gateway for dynamically processing an electronic card transaction in real-time. In particular, the card processing system communicates with an external gateway that services an external funding source for a payment card account in response to a transaction authorization request from a payment network. For example, the card processing system sends a funding request to the external gateway to authorize the electronic card transaction and dynamically determine processing parameters based on characteristics of the electronic card transaction and predetermined parameter ranges associated with the payment card account. Additionally, the card processing system processes the electronic card transaction based on authorization from the external gateway according to the dynamic processing parameters. Furthermore, in one or more embodiments, the card processing system communicates with the external gateway to determine the dynamic processing parameters in real-time according to a response time deadline associated with the transaction authorization request.

As mentioned, in one or more embodiments, the card processing system communicates with an external gateway in response to a transaction authorization request from a payment network. Specifically, the card processing system receives a transaction authorization request routed from a payment network in connection with an electronic card transaction. Additionally, in one or more embodiments, the card processing system parses the transaction authorization request to determine a response time deadline indicating a required time for responding to the payment network regarding the transaction authorization request.

In one or more embodiments, in response to the transaction authorization request, the card processing system sends a funding request to the external gateway. For instance, the card processing system sends the funding request to authorize the transaction authorization request. To illustrate, the card processing system maintains a payment card account funded via an external funding source. Accordingly, the card processing system sends the funding request to determine whether funds are available at the external funding source and to authorize the electronic card transaction.

In one or more additional embodiments, the card processing system sends the funding request with an additional response time deadline indicating a required time for the external gateway to respond to the card processing system regarding the funding request. For example, given the response time deadline associated with the transaction authorization request, the card processing system determines a sub-time period of the response time deadline based on one or more computer processing operations and/or device/server communication operations involved in authorizing the electronic card transaction and determining dynamic processing parameters. Accordingly, card processing system determines the additional response time deadline to response to the transaction authorization request and dynamically determine processing parameters in real-time.

In one or more embodiments, the card processing system determines a set of dynamic processing parameters in response to an authorization of the funding request from the external gateway. In particular, the card processing system determines characteristics of the electronic card transaction based on the transaction authorization request. Furthermore, the card processing system determines one or more parameter ranges corresponding to the payment card account. In at least some embodiments, the card processing system dynamically determines a transaction-specific interest rate or a transaction-specific reward rate associated with the electronic card transaction for processing the electronic card transaction.

According to one or more embodiments, the card processing system processes the electronic card transaction according to the set of dynamic processing parameters. Specifically, based on the card processing system sending a response to the payment network indicating authorization of the funding request, the card processing system processes the electronic card transaction by funding the electronic card transaction from the external funding source. Additionally, the card processing system processes the electronic card transaction according to the set of dynamic processing parameters by performing one or more additional downstream operations to override a set of default processing parameters with the dynamic processing parameters. Thus, the card processing system dynamically determines the processing parameters for funding an electronic card transaction via an external gateway in real-time (e.g., within a response time deadline determined based on the transaction authorization request).

The disclosed card processing system provides a number of benefits over conventional systems. For example, the card processing system improves the flexibility of computing systems that manage card accounts and process electronic card transactions. In contrast to existing systems that rigidly process card-based transactions according to predetermined parameters, the card processing system provides real-time dynamic determination of processing parameters for electronic card transactions. Specifically, the card processing system communicates with an external gateway to dynamically determine one or more processing parameters based on specific details about the electronic card transaction. By dynamically determining such processing parameters via the external gateway within the time requirements associated with a transaction authorization request (e.g., typically several seconds), the card processing system provides dynamic control over the processing of the transaction to an external funding source.

Furthermore, the card processing system improves the efficiency of computing systems that manage card accounts and process electronic card transactions. In contrast to conventional systems with rigid processing functions that lack the ability to perform real-time transaction processing involving third-party funding sources, the card processing system provides real-time dynamic processing of an electronic card transaction involving a third-party funding source. For example, by utilizing “just-in-time” funding to dynamically determine a set of processing parameters in connection with processing an electronic card transaction, the card processing system provides real-time control over the electronic card transaction to the third-party funding source.

Specifically, the card processing system leverages a distributed architecture (e.g., one or more servers at the card processing system and one or more servers via the external gateway) to process electronic card transactions for quickly and dynamically determining processing parameters for overriding default processing parameters in a short amount of time (e.g., several seconds). More specifically, the card processing system can quickly process electronic card transactions with dynamically determined processing parameters without requiring preconfigured processing parameters. The card processing system thus provides improved processing efficiency (e.g., enhanced electronic card transaction processing via increased processing capabilities) over conventional systems that are incapable of dynamically determining processing parameters and require predetermined processing parameters due to the rigid and inefficient architecture of the conventional systems.

In particular, the card processing system efficiently authorizes the electronic card transaction and determines dynamic processing parameters via an external gateway within a communications/processing deadline corresponding to a transaction authorization request. More specifically, in response to receiving the transaction authorization request with a required deadline for responding (e.g., 6-7 seconds), the card processing system performs a specific set of computing operations to authorize the transaction and determine the dynamic processing parameters via an external gateway within the required amount of time. For example, the card processing system determines a sub-time period of the response time deadline for sending a funding request and receiving an authorization response with dynamic processing parameters via the external gateway based on times to perform corresponding communication/processing operations at the card processing system and the external gateway. Accordingly, the card processing system dynamically processes electronic card transactions “just-in-time” according to the specific characteristics of the electronic card transaction and in accordance with transaction controls of a third-party funding source.

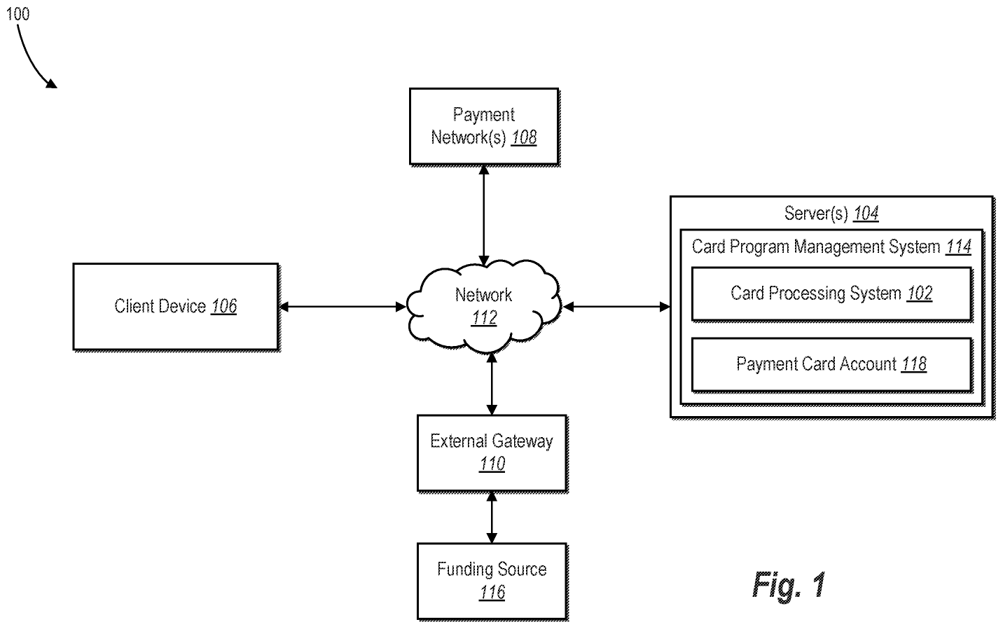

Turning now to the figures, FIG. 1 includes an embodiment of a system environment 100 in which a card processing system 102 operates. In particular, the system environment 100 includes server(s) 104, a client device 106, payment network(s) 108, and an external gateway 110 in communication via a network 112. FIG. 1 illustrates that the card processing system 102 is part of a card program management system 114. Moreover, in one or more embodiments, the system environment 100 includes a funding source 116 in communication with the external gateway 110. As illustrated in FIG. 1, in one or more embodiments, the card program management system 114 includes a payment card account 118.

As shown in FIG. 1, the server(s) 104 include or host the card program management system 114. The server(s) 104 communicate with one or more other components in the system environment 100 to manage cards or card programs for one or more users (e.g., card program managers). For example, the server(s) 104 communicates with a client device to provide card program management for users based on data provided/generated by the payment network(s) 108 in connection with electronic card transactions for one or more payment card accounts and/or card programs. As used herein, the term “card program” refers to software and data that determines when and how one or more cards or card accounts can be used to engage in payment transactions. For example, a card program includes a plurality of card parameter configurations that define attributes of a card associated with the card program including, but not limited to, pricing (e.g., annual percentage rate), fees, usage locations, rewards, discounts, or other attributes. Accordingly, different card programs that have different card parameter configurations provide different usage, benefits, etc., to users of cards corresponding to the different card programs.

Furthermore, as used herein, the term “payment card account” refers to a card-based payment account associated with a card program. To illustrate, a card program includes one or more card program accounts associated with one or more users for using cards to initiate electronic card transactions. In additional embodiments, the payment card account 118 includes one or more processing parameters with one or more parameter ranges for processing electronic card transactions involving the payment card account 118.

Additionally, as used herein, the term “processing parameter” refers to a parameter associated with an electronic card transaction that one or more systems utilize to modify one or more payment card accounts. For instance, a processing parameter includes a parameter that modifies a balance calculation of one or more accounts or layers of an account. To illustrate, a processing parameter includes an interest rate, a reward rate, or other rate that affects the balance of a payment card account, a card reward account (or card reward layer of a payment card account), or other account. Furthermore, as used herein, the term “dynamic processing parameter” refers to a transaction-specific processing parameter determined for use with a particular electronic card transaction.

As used herein, a “card” refers to a physical or digital object corresponding to a card program account for engaging in electronic card transactions. For instance, a card includes a physical credit card or a digital credit card (e.g., in a digital wallet) tied to a payment account (e.g., a card program account) via a credit card number that allows a user to initiate a payment transaction to transfer funds from the payment card account 118 to a recipient account (e.g., a merchant account) via the payment network(s) 108. In one or more embodiments, the payment network(s) 108 include one or more payment gateway systems, one or more card networks (e.g., VISA, MASTERCARD), and/or one or more card issuer systems (e.g., bank issuers) to process electronic card transactions in connection with the card program management system 114. Furthermore, the payment network(s) 108 include one or more servers to generate, store, and transmit data associated with initiating and processing electronic card transactions via the card processing system 102.

In one or more embodiments, the card program management system 114 includes the card processing system 102 to facilitate processing of electronic payment transactions. Specifically, the card processing system 102 communicates with the payment network(s) 108 (e.g., a payment network associated with the client device 106 or another device) to initiate an electronic card transaction involving the payment card account 118. For example, the card processing system 102 receives transaction authorization requests from the payment network(s) 108 for authorizing electronic card transactions initiated via client devices (e.g., the client device 106).

The card processing system 102 also performs additional operations associated with processing electronic card transactions. For example, the card processing system 102 manages ledgers/balances of payment card accounts (e.g., for the payment card account 118) for a plurality of cardholders. As mentioned, in one or more embodiments, the payment card account 118 is funded by the funding source 116, which is external to the server(s) 104. To illustrate, the card processing system manages 102 a ledger/balance of the payment card account but does not fund or hold funds for the payment card account. Rather, the card processing system 102 communicates with the external gateway 110, which services the external/third-party funding source, to fund transactions in connection with the payment card account.

Additionally, as described in more detail below, the card processing system 102 processes electronic card transactions involving the payment card account 118 while providing control over the processing of the electronic card transactions to the funding source 116. In particular, the card processing system 102 communicates with the external gateway 110 to determine dynamic (e.g., transaction-specific) processing parameters for each electronic card transaction involving the funding source 116. Additionally, the card processing system 102 further communicates with the payment network(s) 108 to authorize/decline electronic card transactions involving the payment card account 118. In one or more embodiments, the card processing system 102 also performs additional downstream operations based on authorized electronic card transactions (e.g., using dynamic processing parameters).

Additionally, as used herein, the term “electronic card transaction” refers to a payment transaction in which a payment card account funds a payment from a user to a recipient. To illustrate, an electronic card transaction includes a payment transaction involving the use of a physical card or a digital card. For instance, an electronic card transaction includes a payment transaction via a point-of-sale device or an electronic payment transaction via a mobile application or online application between a payment card account of a user and a recipient account associated with a recipient (e.g., another user or a merchant system) in a peer-to-peer transaction or a peer-to-business transaction.

In one or more embodiments, in connection with managing cards for payment card accounts and/or processing electronic card transactions involving payment card accounts, the card program management system 114 and/or the card processing system 102 provides software and/or hardware for interacting with one or more systems or devices (e.g., the external gateway 110, a client device associated with a card program manager) in the system environment 100. For example, the card processing system 102 provides one or more application programming interfaces (“APIs”) for the systems or devices to perform downstream operations associated with electronic card transactions. To illustrate, the card program management system 114 and/or the card processing system 102 can provide an API with tools for managing card programs, processing/settling electronic card transactions, and utilizing dynamic processing parameters to perform regular account balance calculations or reward balances. Furthermore, in some embodiments, the card processing system 102 provides the API for determining dynamic processing parameters of electronic card transactions.

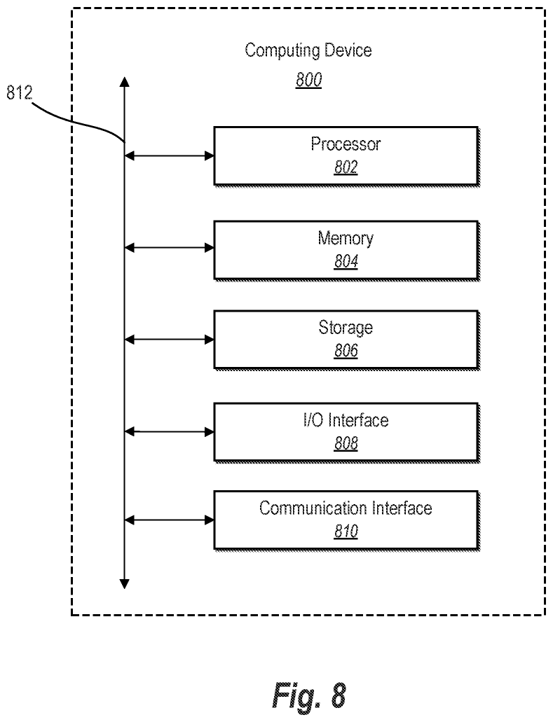

In one or more embodiments, the server(s) 104 include a variety of computing devices, including those described below with reference to FIG. 8. For example, the server(s) 104 includes one or more servers for storing and processing data associated with card program management and electronic card transaction processing. In some embodiments, the server(s) 104 also include a plurality of computing devices in communication with each other, such as in a distributed storage environment. In some embodiments, the server(s) 104 communicate with a plurality of issuing systems and issuing system devices or other systems and devices of one or more entities based on established relationships between the card program management system 114, the card processing system 102, and the one or more entities. To illustrate, the server(s) 104 communicate with various entities or systems including financial institutions (e.g., issuing banks associated with payment cards via the payment network(s) 108), payment card networks associated with processing payment transactions involving payment cards, payment gateways (e.g., the external gateway 110), merchant systems, client devices, or other systems.

In addition, in one or more embodiments, the card program management system 114 and/or the card processing system 102 are implemented on one or more servers. For example, the card program management system 114 and/or the card processing system 102 can be partially or fully implemented on a plurality of servers. To illustrate, the card program management system 114 and the card processing system 102 can be implemented in a distributed environment. In one or more embodiments, each server handles requests for managing card program accounts and managing databases.

In one or more embodiments, the client device 106 includes a computing device that initiates electronic payment transactions via the payment network(s) 108. For example, the client device 106 includes a user device, such as a smartphone, desktop computer, laptop, or other computing device that enables electronic card transactions with one or more entities (e.g., via web applications or standalone applications). In some embodiments, the client device 106 includes a recipient device that hosts a web application or standalone applications and communicates with the payment network(s) 108 to initiate electronic card transactions. In alternative examples, the client device 106 includes a point-of-sale device including a card reader, chip reader, or other device to initiate electronic card transactions between a sending user and a recipient user.

In one or more embodiments, the external gateway 110 includes one or more servers for servicing the funding source 116. For example, the external gateway 110 includes one or more servers of a bank, issuing system, or other entity that includes the funding source 116. Alternatively, the external gateway 110 includes one or more servers that communicates with a separate system including the funding source 116 to facilitate/manage electronic card transactions involving the funding source 116. Accordingly, the external gateway includes a separate entity external to the payment network(s) 108 and the server(s) 104 (e.g., separate from the card program management system 114 and the card processing system 102).

Additionally, the funding source 116 includes a system or device(s) that manages funding and approval of electronic card transactions involving a payment card account managed by the card processing system. Specifically, the funding source 116 can include a system that manages a card program associated with the payment card account. Furthermore, the funding source 116 can be external to (e.g., separate from) the card processing system 102 and external to the payment network(s) 108. In some embodiments, the funding source 116 includes an entity separate from an issuer (e.g., a non-bank entity) that manages a card program and/or provides loans/credit/funding of payment card accounts. In alternative embodiments, the funding source 116 is separate from a card program manager and the funding source 116, and/or the card program manager determines dynamic processing parameters.

Additionally, as shown in FIG. 1, the system environment 100 includes the network 112. The network 112 enables communication between components of the system environment 100. In one or more embodiments, the network 112 may include the Internet or World Wide Web. Additionally, the network 112 can include various types of networks that use various communication technology and protocols, such as a corporate intranet, a virtual private network (VPN), a local area network (LAN), a wireless local network (WLAN), a cellular network, a wide area network (WAN), a metropolitan area network (MAN), or a combination of two or more such networks. Indeed, the server(s) 104, the card program management system 114, the card processing system 102, the client device 106, and the external gateway 110 communicate via the network 112 using one or more communication platforms and technologies suitable for transporting data and/or communication signals, including any known communication technologies, devices, media, and protocols supportive of data communications, examples of which are described with reference to FIG. 8. Additionally, in one or more embodiments, one or more of the various components of the system environment 100 communicate using protocols for financial information communications such as PCI standards or other protocols.

In one or more embodiments, although FIG. 1 is described in relation to card-based transactions, the card processing system 102 can utilize the dynamic processing operations in connection with other types of electronic transactions. In particular, the card processing system 102 can utilize dynamic processing parameters to override default processing parameters of any type of transactions. For example, the card processing system 102 can determine dynamic processing parameters to override default processing parameters for electronic transactions associated with savings accounts, checking accounts, or other payment accounts.

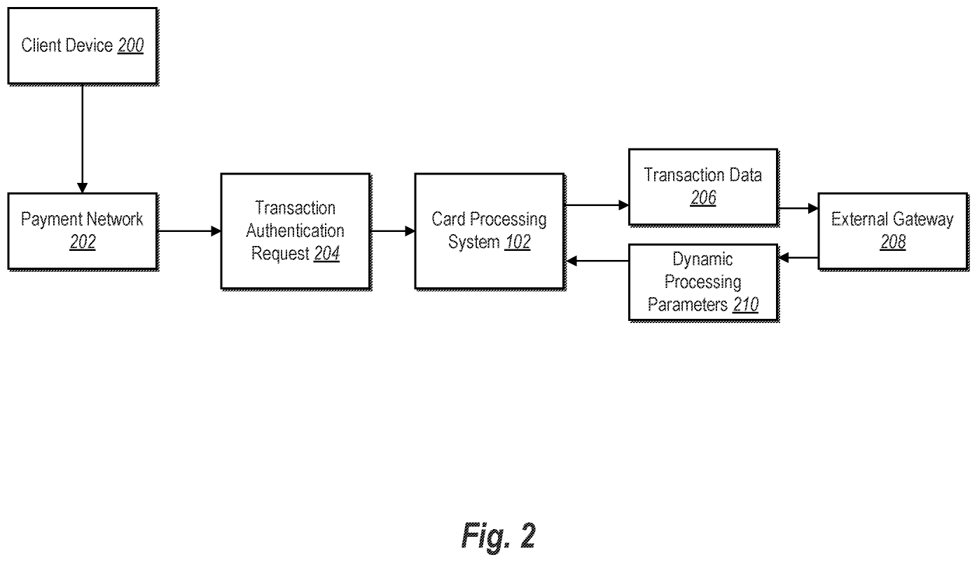

As mentioned, the card processing system 102 provides dynamic processing of electronic card transactions involving third-party funding sources. FIG. 2 illustrates an overview of a process in which the card processing system 102 dynamically determining processing parameters for electronic card transactions via an external gateway. Specifically, FIG. 2 illustrates that the card processing system 102 determines dynamic processing parameters for overriding specific parameters of an electronic card transaction in connection with providing real-time control over processing of the electronic card transaction to the third-party funding source of the external gateway 110.

In one or more embodiments, as illustrated in FIG. 2, a client device 200 is in communication with a payment network 202 for initiating electronic card transactions. Specifically, the client device 200 initiates an electronic card transaction with the payment network 202 to transfer funds from a sender payment card account to a recipient payment account. For example, as mentioned, the client device 200 includes a computing device (e.g., a point-of-sale) device that initiates an electronic card transaction between two entities by sending an indication of the electronic card transaction to the payment network 202. To illustrate, the indication of the electronic card transaction includes details associated with the electronic card transaction for processing the electronic card transaction.

In one or more embodiments, as illustrated in FIG. 2, the payment network 202 sends a transaction authorization request 204 to the card processing system 102 in connection with processing an electronic card transaction. For instance, the payment network 202 generates and sends the transaction authorization request 204 to the card processing system 102 to authorize funding of the electronic card transaction according to the transaction details. In some embodiments, as described in more detail below, the payment network 202 sends the transaction authorization request 204 with a response time deadline for performing the electronic card transaction in real-time.

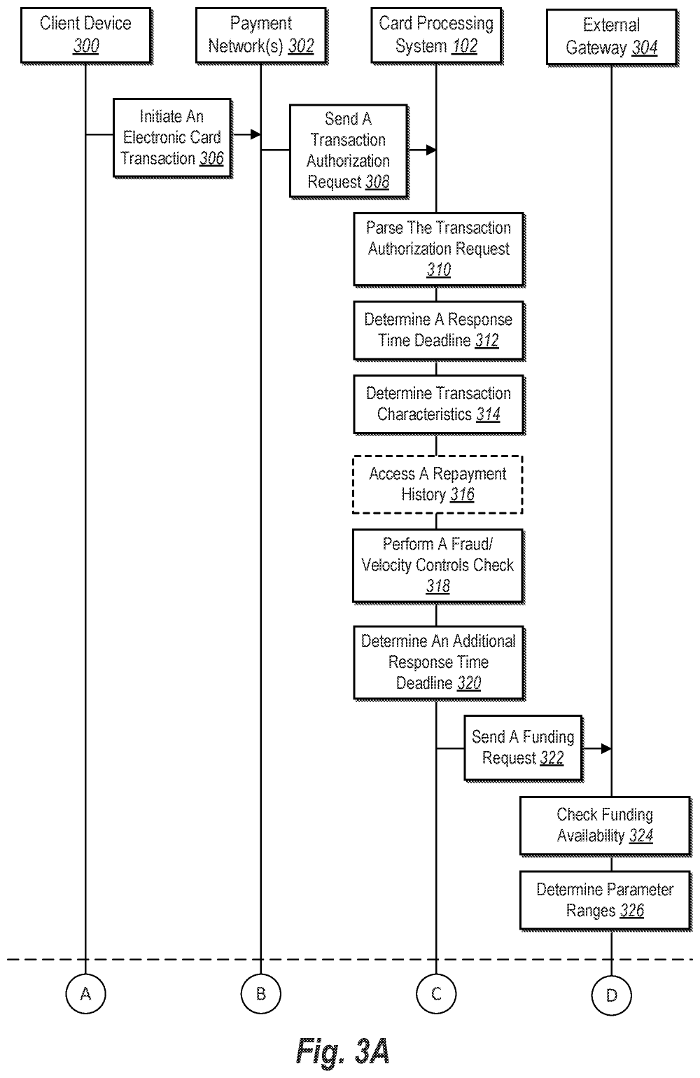

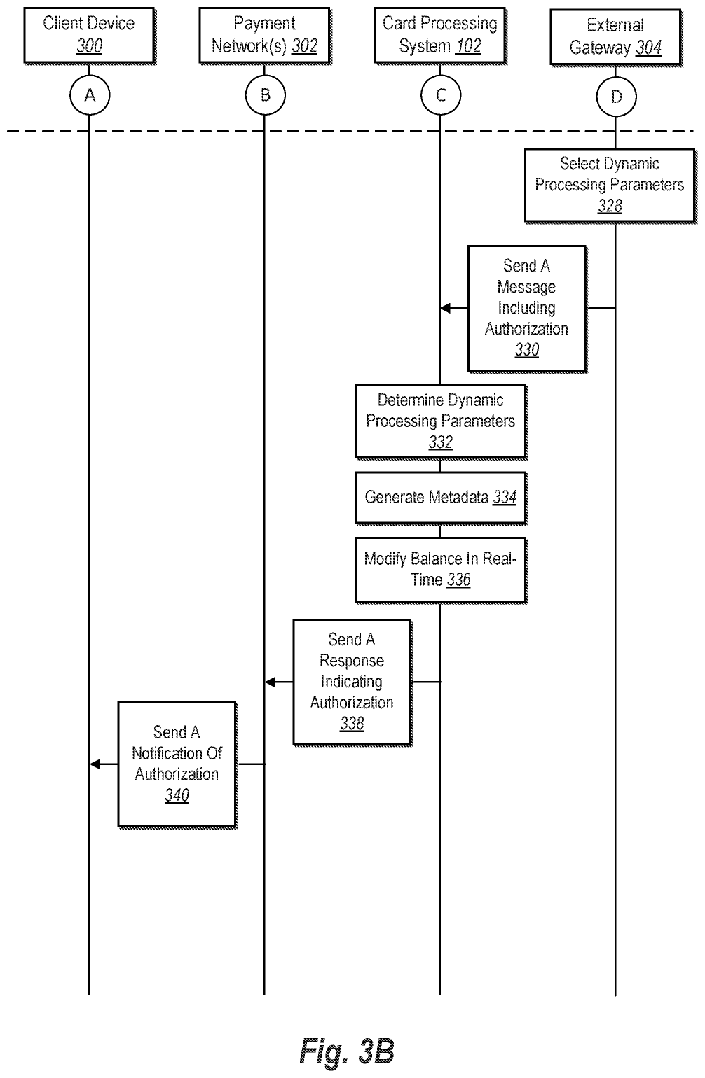

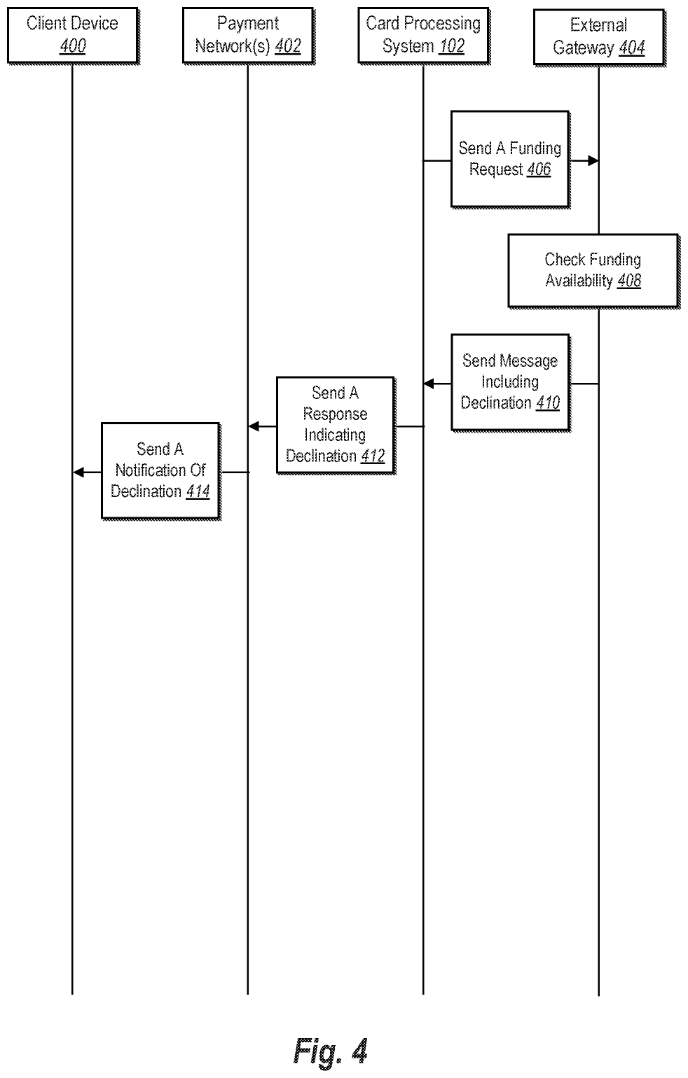

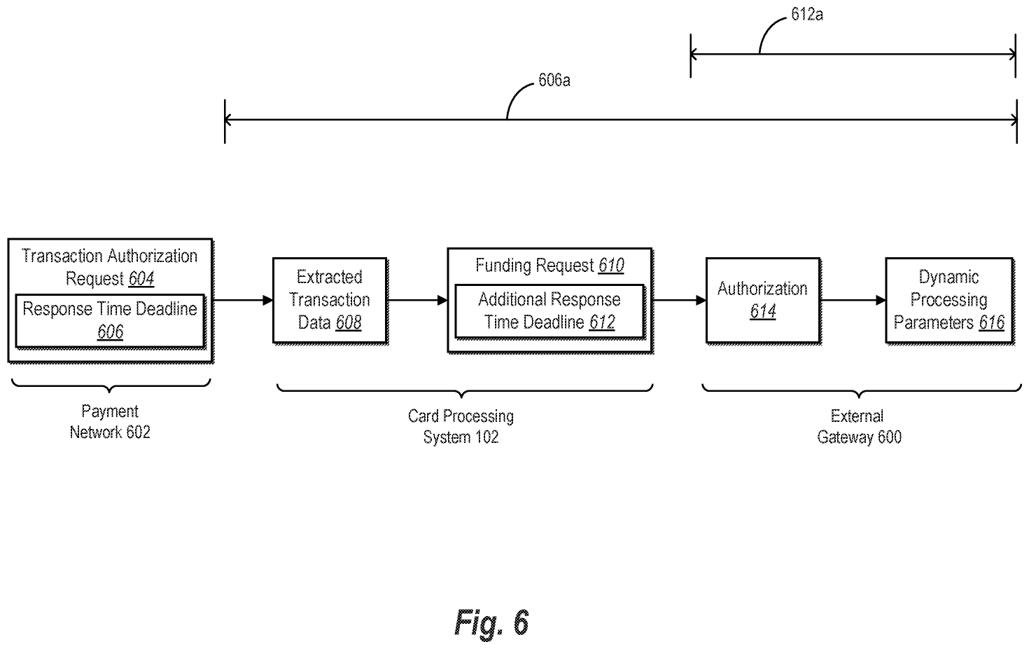

According to one or more embodiments, the card processing system 102 sends transaction data 206 to an external gateway 208 associated with a third-party funding source for authorizing the electronic card transaction. In particular, the card processing system 102 generates a funding request to authorize a transfer of funds in connection with the electronic card transaction based on the transaction data 206. Additionally, the card processing system 102 can send the funding request to determine dynamic processing parameters 210 from the external gateway according to the specific transaction details of the electronic card transaction in real-time (e.g., according to the response time deadline). More specifically, the FIGS. 3A-3B and FIG. 4 and the corresponding description provide additional detail associated with authorizing an electronic card transaction and determining dynamic processing parameters via an external gateway. Furthermore, FIG. 6 and the corresponding description provide additional detail with respect to authorizing an electronic card transaction and determining dynamic processing parameters in real-time according to a response time deadline associated with a transaction authorization request.

FIGS. 3A-3B illustrate a flowchart of a plurality of operations in a process for processing an electronic card transaction according to dynamically determined processing parameters. Specifically, the electronic card transaction includes a transaction to transfer funds from a payment card account of a sending user to an account of a recipient user. For example, the electronic card transaction involves a plurality of devices/systems communicating to perform a plurality of different acts. More specifically, FIG. 3A illustrates a client device 300, payment network(s) 302, the card processing system 102, and an external gateway 304 in communication to perform the different acts.

In one or more embodiments, as illustrated in FIG. 3A, a client device 300 performs an act 306 of initiating an electronic card transaction. In particular, as previously mentioned, the client device 300 initiates the electronic card transaction in connection with a purchase of a good or service by a first entity (e.g., an individual) from a second entity (e.g., a merchant system). Additionally, in some embodiments, the client device 300 sends a payment message to the payment network(s) 302 including details about the electronic card transaction. For instance, the payment message includes, but is not limited to, a timestamp, a geographic location of the transaction, a payment amount, an account identifier, or identifiers corresponding to the entities involved in the electronic card transaction.

According to one or more embodiments, in response to the payment message indicating the electronic card transaction, the payment network(s) 302 performs an act 308 of sending a transaction authorization request to the card processing system 102 to authorize the electronic card transaction. For example, the payment network(s) 302 route the transaction authorization request to the card processing system 102. More specifically, one or more servers of the payment network(s) 302 route the transaction authorization request to one or more servers including the card processing system 102.

In one or more additional embodiments, the payment network(s) 302 send the transaction authorization request to the card processing system 102 with (e.g., alongside or including) a response time deadline. In particular, the payment network(s) 302 generate the response time deadline for authorizing the electronic card transaction in real-time. For example, the payment network(s) 302 can generate the response time deadline to be a few seconds (e.g., 6-7 seconds). To illustrate, the payment network(s) 302 include the response time deadline as a communication requirement time for a server that receives the request to respond to the request before the payment network(s) time out the request. In alternative examples, the payment network(s) 302 can generate the response time deadline to be more or less time according to the specific implementation for processing the electronic card transaction in real-time.

As illustrated in FIG. 3A, according to one or more embodiments, the card processing system 102 performs an act 310 of parsing the transaction authorization request to determine details associated with the electronic card transaction. For instance, as illustrated in FIG. 3A, the card processing system 102 performs an act 312 of determining a response time deadline in connection with the transaction authorization request. For example, the card processing system 102 extracts the response time deadline from the transaction authorization request. Alternatively, the card processing system 102 extracts the response time deadline from a packet containing or otherwise associated with the transaction authorization request.

In one or more embodiments, the card processing system 102 also performs an act 314 of determining transaction characteristics based on the transaction authorization request. In particular, the card processing system 102 extracts transaction details from the transaction authorization request. To illustrate, the card processing system 102 extracts characteristics of the electronic card transaction including, but not limited to, a timestamp, a geographic location of the transaction (e.g., based on a GPS, IP address, or other location indicator of the client device 300), a payment amount, an account identifier, a sender identifier, or a recipient identifier.

According to one or more embodiments, the card processing system 102 optionally performs an act 316 of accessing a repayment history associated with a payment card account in connection with the electronic card transaction. For example, the card processing system 102 identifies the payment card account utilizing the details from the transaction authorization request. In one or more embodiments, the payment card account is stored on, and managed/maintained by, one or more servers of the card processing system 102. The card processing system 102 can identify the payment card account according to an account number (e.g., a credit/debit card number) associated with the electronic card transaction.

Additionally, the card processing system 102 accesses a previously stored repayment history stored on the one or more servers of the card processing system 102 to determine amounts, timestamps, and transaction identifiers associated with previous electronic card transactions involving the payment card account. To illustrate, the card processing system 102 can determine whether a user of the payment card account has repaid credit transactions on the payment card account in a timely manner, whether the payment card account has any corresponding late payments, etc. In additional embodiments, the card processing system 102 determines specific details of the previous electronic card transactions relative details of the current electronic card transaction (e.g., in one or more comparisons).

In one or more embodiments, the card processing system 102 performs an act 318 of performing a fraud/velocity controls check for the electronic card transaction. In particular, the card processing system 102 utilizes the transaction characteristics to determine whether the electronic card transaction indicates potential fraudulent activity. For example, the card processing system 102 can determine a risk level for the electronic card transaction based on a geographic location/IP address of the sender user and/or the recipient user, a payment amount of the electronic card transaction, a timestamp associated with the electronic card transaction, a transaction type (e.g., a particular good or service), or other details associated with the electronic card transaction. Based on the risk level, the card processing system 102 can determine whether the electronic card transaction passes the fraud check (e.g., a risk level above a threshold fails the risk check and a risk level below the threshold passes the risk check).

Additionally, the card processing system 102 can perform velocity controls to determine whether the electronic card transaction meets recipient-specific thresholds. For example, the card processing system 102 determines settings associated with the recipient user including transaction thresholds for electronic card transactions. To illustrate, the card processing system 102 can compare a payment amount of the electronic card transaction to one or more threshold values to determine whether the payment amount is acceptable given the velocity controls for the recipient user. In some embodiments, the card processing system 102 includes a first set of servers to parse the transaction authorization request and perform the fraud/velocity controls checks.

In response to determining that the electronic card transaction passes the fraud/velocity controls check, the card processing system 102 can communicate with the external gateway 304 to fund the transaction from a third-party funding source serviced by the external gateway 304. For instance, because the card processing system 102 does not fund (or hold funds) for the payment card account, the card processing system 102 communicates with the external gateway 304 to authorize and fund the electronic card transaction in connection with the payment card account. Thus, the card processing system 102 provides control over the electronic card transaction to the third-party funding source via the external gateway 304. Furthermore, the card processing system 102 communicates with the external gateway 304 within the response time deadline of the transaction authorization request for authorizing/processing the electronic card transaction via the external gateway 304 in real-time.

In one or more embodiments, the card processing system 102 includes a second set of servers to communicate with the external gateway 304 to authorize and fund the electronic card transaction. Accordingly, the first set of servers of the card processing system 102 that parse the transaction authorization request and perform the fraud/velocity controls checks can send the relevant transaction data to the second set of servers of the card processing system 102 to communicate with the external gateway 304. In some embodiments, the first set of servers provide communications to the second set of servers with an additional response time deadline based on the amount of time available to meet the response time deadline of the payment network(s) 302. Alternatively, the card processing system 102 performs operations involved with processing the electronic card transaction based on the transaction authorization request at a single set of servers.

According to one or more embodiments, the card processing system 102 performs an act 320 of determining an additional response time deadline in connection with funding the electronic card transaction via the external gateway 304. Specifically, performing operations associated with processing the electronic card transaction at the card processing system 102 takes time. For example, parsing the transaction authorization request, accessing the repayment history, and performing fraud/velocity controls checks can take time, thereby reducing the available amount of time for meeting the response time deadline. Accordingly, the card processing system 102 determines the additional response time deadline as a sub-time period of the response time deadline based on the amount of processing time used to perform the various operations and the amount of time remaining in the response time deadline. To illustrate, the additional response time deadline can be 2-3 seconds, or another time based on the amount of time available to meet the response time deadline and/or based on the amount of time for the external gateway 304 to authorize the electronic card transaction.

As illustrated in FIG. 3A, the card processing system 102 performs an act 322 of sending a funding request to the external gateway 304. For example, the card processing system 102 generates the funding request to fund the electronic card transaction via the payment card account for a payment amount of the electronic card transaction. Additionally, the card processing system 102 includes details of the electronic card transaction, such as an account identifier, identifiers of the users involved in the electronic card transaction, the geographic location, or other transaction characteristics determined from the transaction authorization request. In some embodiments, the card processing system 102 includes sending the funding request (e.g., via synchronous messaging) with the additional response time deadline (e.g., within the funding request or otherwise along with the funding request).

In one or more embodiments, in response to the funding request, the external gateway 304 performs an act 324 of checking funding availability for the payment card account to determine whether to authorize or decline the electronic card transaction. For example, as mentioned, the external gateway 304 can include or otherwise communicate with a system that includes the third-party funding source. The external gateway 304 can determine the third-party funding source that funds the payment card account based on an account identifier in the funding request. Additionally, the external gateway 304 can authorize or deny the electronic card transaction based on whether the third-party funding source includes funds (e.g., available credit) to fund the electronic card transaction.

According to one or more embodiments, the external gateway 304 determines how to process the electronic card transaction based on the data received from the card processing system 102. For example, as illustrated in FIG. 3A, the external gateway 304 performs an act 326 of determining parameter ranges associated with the payment card account. In particular, the parameter ranges include a set of predetermined range of values for one or more processing parameters associated with the payment card account. To illustrate, the external gateway 304 can determine that the payment card account has a possible range of values for an interest rate associated with electronic card transactions involving the payment card account (e.g., 5%-30%). Additionally, the external gateway 304 can determine that the payment card account has a possible range of values for a reward rate associated with electronic card transactions involving the payment card account (e.g., 1%-5%).

In some embodiments, the parameter ranges are predetermined based on a policy associated with the payment card account. Specifically, the card processing system 102 and/or the external gateway 304 (in connection with the third-party funding source) determine the policy associated with the payment card account during creation of the payment card account (e.g., based on an application for a payment card account). For example, the external gateway 304 stores the parameter ranges for the payment card account in connection with the third-party funding source. Furthermore, in one or more embodiments, the external gateway 304 creates the policy with disclosures that meet Payment Card Industry (“PCI”) standards, such as by including terms and conditions that indicate the variable range of processing parameters depending on the specifics of each electronic card transaction.

In one or more embodiments, the external gateway 304 determines processing parameters for the electronic card transaction based on the parameter ranges associated with the payment card account. In particular, as illustrated in FIG. 3B, the external gateway 304 performs an act 328 of selecting dynamic processing parameters for the electronic card transaction. For instance, the external gateway 304 utilizes the transaction characteristics from the funding request to select one or more transaction-specific processing parameters based on the parameter ranges. To illustrate, the external gateway 304 utilizes the payment amount, the identifiers of the entities (e.g., a merchant identifier), geographic location, or other data to determine the dynamic processing parameters.

As an example, the external gateway 304 determines a transaction-specific interest rate and/or a transaction-specific reward rate for the electronic card transaction based on the transaction data. More specifically, in response to determining that the electronic card transaction corresponds to a specific merchant, the external gateway 304 determines the dynamic processing parameters within the parameter ranges for the specific merchant. Additionally, in response to determining that the electronic card transaction corresponds to a different merchant, the external gateway 304 can determine different dynamic processing parameters within the parameter ranges. The external gateway 304 can determine the dynamic processing parameters based on a combination of a plurality of characteristics of the electronic card transaction (e.g., a merchant identifier and a transaction type such as a “gas purchase”). The external gateway 304 can further determine the dynamic processing parameters based on a specific time of the electronic card transaction (e.g., based on whether the electronic card transaction occurs within a promotional time window).

In one or more embodiments, the external gateway 304 determines the dynamic processing parameters based on historical data associated with the payment card account. For example, the external gateway 304 determines the dynamic processing parameters based on the repayment history associated with the payment card account. To illustrate, the card processing system 102 sends the repayment history (or a recent repayment history) of the payment card account to the external gateway 304 with the funding request. The external gateway 304 utilizes the repayment history to determine one or more transaction-specific processing parameters for the electronic card transaction.

In one or more additional embodiments, the card processing system 102 generates a transaction score based on the transaction data associated with the electronic card transaction. In particular, the card processing system 102 generates the transaction score based on the repayment history associated with the payment card account. The card processing system 102 can also utilize information associated with the sender user or recipient user to generate the transaction score. For example, the card processing system 102 assigns a value to each characteristic and combines the values by weighting the values according to an importance of each characteristic. The card processing system 102 can provide the transaction score to the external gateway 304, which can use the transaction score to determine the dynamic processing parameters.

As illustrated in FIG. 3B, in response to authorizing the electronic card transaction and determining the dynamic processing parameters, the external gateway 304 performs an act 330 of sending a message including authorization to the card processing system 102. For example, the external gateway 304 sends the message including the authorization of the transaction authorization request and the dynamic processing parameters. To illustrate, the external gateway 304 passes the dynamic processing parameters in metadata of the message (e.g., in a “memo” field) including authorization of the electronic card transaction. According to one or more embodiments, the external gateway 304 utilizes an API of the card processing system 102 to pass the dynamic processing parameters to the card processing system 102 with the message including authorization.

In one or more embodiments, the external gateway 304 sends the message including authorization to the card processing system 102 within a specific amount of time. For example, as mentioned, the card processing system 102 can send the funding request with an additional response time deadline. Accordingly, the external gateway 304 can send the message authorizing the electronic card transaction within the additional response time deadline. In response to the external gateway 304 sending the authorization within the additional response time deadline, the card processing system 102 can continue processing the electronic card transaction.

As illustrated in FIG. 3B, the card processing system 102 performs an act 332 of determining dynamic processing parameters. Specifically, the card processing system 102 utilizes the information in the message including authorization from the external gateway 304 to determine the dynamic processing parameters for the electronic card transaction. For example, the card processing system 102 can parse metadata associated with the message to determine the dynamic processing parameters. The card processing system 102 can store the dynamic processing parameters for later use with one or more downstream operations. In some embodiments, the external gateway 304 determines not to dynamically select processing parameters for a particular electronic card transaction and does not send dynamic processing parameters to the card processing system 102. Accordingly, the card processing system 102 can utilize the default processing parameters for such electronic card transactions.

In response to determining the dynamic processing parameters, as illustrated in FIG. 3B, the card processing system 102 performs an act 334 of generating metadata. For example, the card processing system 102 accesses the metadata for the electronic card transaction (e.g., in connection with the transaction authorization request) from the payment card account. The card processing system 102 can store the dynamic processing parameters by overriding default processing parameters for the electronic card transaction within the metadata.

In one or more embodiments, a payment card account has a set of default processing parameters that the card processing system 102 utilizes to process electronic card transactions involving the payment card account. In particular, the card processing system 102 (or another entity such as the payment network(s) 302 or the external gateway 304) can determine the set of default processing parameters based on parameter ranges for the payment card account. The default processing parameters may also be based on common processing parameters for similar electronic card transactions. Accordingly, the card processing system 102 can override the default processing parameters by modifying one or more values within corresponding metadata fields.

In addition to storing the dynamic processing parameters, in one or more embodiments, the card processing system 102 performs an act 336 of modifying a balance in real-time for the payment card account. Specifically, the card processing system 102 maintains a ledger/balance for the payment card account including database events that affect a value of one or more layers of the payment card account. The card processing system 102 modifies the balance of the payment card account in real-time (e.g., without receiving or holding funds for the payment card account from the third-party funding source) by increasing or decreasing the balance based on the payment amount in the transaction authorization request. Accordingly, the card processing system 102 maintains a zero balance for the payment card account by internally modifying the balance to account for the electronic card transaction to authorize the electronic card transaction “just-in-time” (e.g., in real-time according to the response time deadline).

As illustrated in FIG. 3B, the card processing system 102 also performs an act 338 of sending a response indicating authorization of the electronic card transaction. In one or more embodiments, the card processing system 102 generates a response message indicating that the external gateway 304 (e.g., the third-party funding source via the external gateway 304) has authorized the electronic card transaction. The card processing system 102 (e.g., the first set of servers, as described above) can provide the response message to the payment network(s) 108 within the response time deadline indicated by the payment network(s) 108. Additionally, the response message can indicate that the payment card account has sufficient funds for the electronic card transaction. FIG. 3B further illustrates that the payment network(s) 302 perform an act 340 of sending a notification of authorization to the client device 300.

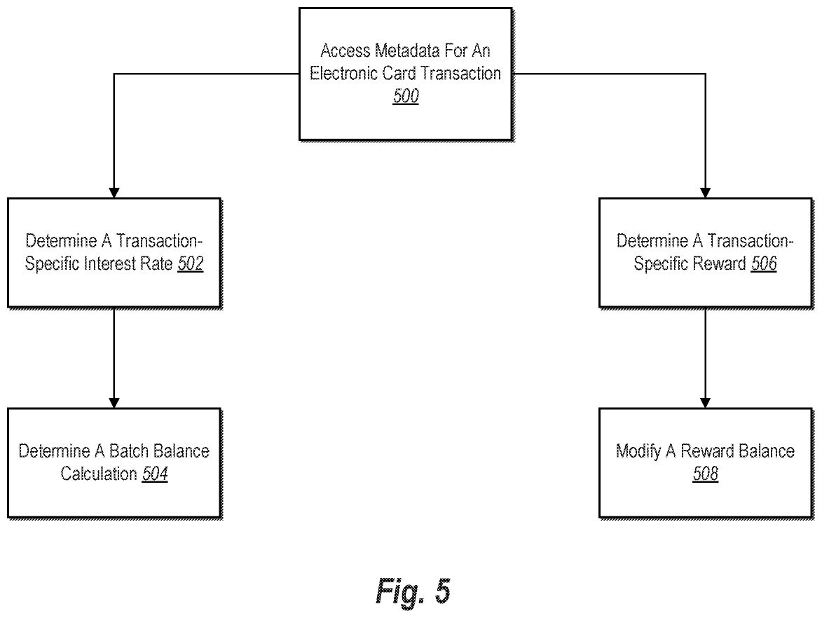

In one or more embodiments, the card processing system 102 also performs one or more downstream operations based on authorization of the electronic card transaction and the dynamic processing parameters. For example, as described in more detail with respect to FIG. 5, the card processing system 102 can utilize dynamic processing parameters to modify one or more balances in response to authorization of the electronic card transaction. To illustrate, the card processing system 102 can modify one or more balances based on transaction-specific interest rate and/or a transaction-specific reward rate.

According to one or more embodiments, the card processing system 102 and/or an external gateway declines a transaction authorization request for an electronic card transaction. FIG. 4 illustrates a flowchart diagram of a subset of operations in connection with declining an electronic card transaction. Specifically, FIG. 4 illustrates a client device 400, payment network(s) 402, the card processing system 102, and an external gateway 404 in communication to perform the different acts associated with declining an electronic card transaction.

As illustrated in FIG. 4, the card processing system 102 performs an act 406 of sending a funding request to the external gateway 404 in connection with an electronic card transaction. In particular, in response to receiving a transaction authorization request from the payment network(s) 402 and/or one or more additional operations at the card processing system 102, the card processing system 102 sends the funding request to the external gateway 404. As mentioned above, the funding request can include transaction data associated with the electronic card transaction.

In one or more embodiments, the external gateway 404 performs an act 408 of checking funding availability. Specifically, the external gateway 404 checks whether a third-party funding source that funds a payment card account associated with the electronic card transaction has sufficient funds/credit available to fund a payment amount of the electronic card transaction. In response to determining that the third-party funding source does not have sufficient funding availability, the external gateway 404 can decline the electronic card transaction. In additional embodiments, the external gateway 404 also determines to decline the electronic card transaction in response to performing one or more fraud checks or other checks based on characteristics of the electronic card transaction in connection with the third-party funding source. Accordingly, the external gateway 404 does not determine dynamic processing parameters based on declining the electronic card transaction.

As illustrated in FIG. 4, in response to determining to decline the electronic card transaction, the external gateway 404 performs an act 410 of sending a message including a declination of the electronic card transaction. For instance, the external gateway sends the message including declination of the electronic card transaction to the card processing system 102 within a specific amount of time. To illustrate, as mentioned, the card processing system 102 sends the funding request with an additional response time deadline based on a response time deadline associated with a transaction authorization request from the payment network(s) 402. The external gateway 404 thus sends the message including the declination within the additional response time deadline. Furthermore, because the external gateway 404 declined the electronic card transaction, the card processing system 102 does not determine dynamic processing parameters for the electronic card transaction.

In one or more additional embodiments, the card processing system 102 can decline the electronic card transaction in response to determining that the external gateway 404 does not meet an additional response time deadline. For example, in response to determining that the external gateway 404 has not responded with authorization of the electronic card transaction within the additional response time deadline, the card processing system 102 can decline the electronic card transaction. In connection with declining the electronic card transaction prior to receiving a response from the external gateway 404, the card processing system 102 can notify the external gateway 404 that the funding request timed out.

According to one or more embodiments, the card processing system 102 performs an act 412 of sending a response indicating the declination of the electronic card transaction to the payment network(s) 402. In one or more embodiments, the card processing system 102 performs one or more downstream operations based on the declination of the electronic card transaction. Additionally, as illustrated in FIG. 4, the payment network(s) 402 perform an act 414 of sending a notification of declination of the electronic card transaction to the client device 400.

FIG. 5 illustrates that the card processing system 102 performs one or more downstream operations based on an authorized electronic card transaction. In particular, the card processing system 102 performs one or more downstream operations associated with the electronic card transaction based on dynamic processing parameters. For example, as previously mentioned, the card processing system 102 utilizes dynamic processing parameters to override default processing parameters for an electronic card transaction within metadata associated with the electronic card transaction. According to one or more embodiments, the card processing system 102 overwrites one or more metadata fields associated with the electronic card transaction to override the default processing parameters with the dynamic processing parameters.

As illustrated in FIG. 5, to perform one or more downstream operations associated with an electronic card transaction, the card processing system 102 performs an act 500 of accessing metadata for an electronic card transaction. Specifically, the card processing system 102 accesses the metadata stored at one or more servers of the card processing system 102 in connection with one or more electronic card transactions. To illustrate, the card processing system 102 accesses metadata for a single electronic card transaction to perform a downstream operation based on the dynamic processing parameters of the single electronic card transaction. Alternatively, the card processing system 102 accesses metadata for a plurality of electronic card transactions to perform a downstream operation based on dynamic processing parameters of the plurality of electronic card transactions.

For example, as illustrated in FIG. 5, the card processing system 102 performs an act 502 of determining a transaction-specific interest rate from the metadata. For instance, the card processing system 102 extracts the transaction-specific interest rate from a specific metadata field stored for the electronic card transaction. According to one or more embodiments, the card processing system 102 dynamically determines that the transaction-specific interest rate includes a specific interest rate based on characteristics of the electronic card transaction and stores the transaction-specific interest rate in the metadata (e.g., by overwriting a default interest rate in the metadata). Accordingly, the card processing system 102 extracts the transaction-specific interest rate from the metadata to use in performing one or more downstream operations.

In one or more embodiments, the card processing system 102 performs an act 504 of determining a batch balance calculation for a payment card account. In particular, the card processing system 102 determines a balance calculation based on a plurality of electronic card transactions during a specific time period (e.g., a daily balance calculation for interest on the payment card account). For example, the card processing system 102 utilizes a plurality of transaction-specific interest rates for a plurality of electronic card transactions that occurred within the specific time period to determine the balance calculation. To illustrate, in response to determining that the transaction-specific interest rate includes a 5% interest rate based on the transaction characteristics.

Additionally, in some embodiments, additional electronic card transactions occurring within the time period have different interest rates that fall within the parameter ranges corresponding to the payment card account. For example, the card processing system 102 extracts a first interest rate of 2% from metadata corresponding to a first electronic card transaction and a second interest rate of 15% from metadata corresponding to a second electronic card transaction. Thus, the card processing system 102 utilizes the different transaction-specific interest rates to determine the balance calculation for a batch of electronic card transactions including the first electronic card transaction and the second electronic card transaction.

In additional embodiments, as illustrated in FIG. 5, the card processing system 102 performs an act 506 of determining a transaction-specific reward rate. Specifically, the card processing system 102 extracts the transaction-specific reward rate from the metadata stored for the electronic card transaction. For example, the card processing system 102 dynamically determines that the transaction-specific reward rate includes a specific interest rate based on characteristics of the electronic card transaction and stores the transaction-specific reward rate in the metadata (e.g., by overwriting a default interest rate in the metadata. Thus, the card processing system 102 extracts the transaction-specific reward rate from the metadata to use in performing one or more downstream operations.

In some embodiments, the card processing system 102 performs an act 508 of modifying a reward balance of a payment card account. For example, the card processing system 102 determines an amount of reward based on the transaction-specific reward rate for the electronic card transaction and a payment amount of the electronic card transaction. The card processing system 102 uses the reward amount to modify a reward balance of the payment card account (e.g., by incrementing a current reward balance by the reward amount). To illustrate, in response to dynamically determining that the transaction-specific reward rate for the electronic card transaction is 5% in real-time (e.g., based on the merchant identifier, transaction type), the card processing system 102 determines the reward amount and increments the reward balance by the reward amount.

In one or more embodiments, the card processing system 102 utilizes a plurality of dynamic processing parameters to perform a plurality of downstream operations based on an electronic card transaction. In particular, the card processing system 102 can dynamically determine a transaction-specific interest rate and a transaction-specific reward rate based on an electronic card transaction. The card processing system 102 can also perform a plurality of downstream operations based on the transaction-specific interest rate and the transaction-specific reward rate from stored metadata for the electronic card transaction. For instance, the card processing system 102 can determine a batch balance calculation based on the transaction-specific interest rate and modify a reward balance based on the transaction-specific reward rate in connection with processing the electronic card transaction.

As mentioned, the card processing system 102 performs a plurality of operations for dynamically processing a payment transaction with transaction-specific processing parameters in real-time. Specifically, the card processing system 102 performs operations to communicate with an external gateway 600 to authorize an electronic card transaction and determine dynamic processing parameters in real-time according to a predetermined amount of time indicated by a payment network 602. For example, the payment network 602 sends a transaction authorization request 604 to the card processing system 102 to authorize the electronic card transaction with a response time deadline 606. Furthermore, FIG. 6 illustrates a timeline 606a corresponding to the response time deadline 606.

As illustrated in FIG. 6, the card processing system 102 determines extracted transaction data 608 from the transaction authorization request 604. For instance, the card processing system 102 extracts the transaction data to determine characteristics of the electronic card transaction including, but not limited to, a payment amount, sender/recipient identifiers, an account identifier, a transaction type, a geographic location of a client device initiating the transaction, or a geographic location of a recipient. Furthermore, FIG. 6 illustrates that the card processing system 102 generates a funding request 610 based on the extracted transaction data 608 to request authorization of the electronic card transaction from the external gateway 600. In some embodiments, the funding request 610 includes instructions that cause the external gateway 600 to perform specific actions for authorizing funding of the electronic card transaction (e.g., based on an API provided by the card processing system 102) within the response time deadline 606.

In one or more embodiments, the card processing system 102 also determines a sub-time period of the response time deadline 606 for communicating with the external gateway 600. Specifically, FIG. 6 illustrates that the card processing system 102 includes an additional response time deadline 612 with the funding request 610 to ensure that the card processing system 102 can communicate with the external gateway 600 and respond to the transaction authorization request 604 within the response time deadline 606. For example, the card processing system 102 determines the additional response time deadline 612 based on a remaining amount of time after determining the extracted transaction data 608 and generating/sending the funding request 610 and an amount of time required to perform additional operations associated with authorizing the electronic card transaction. FIG. 6 illustrates an additional timeline 612a corresponding to the additional response time deadline 612. As shown, the additional timeline 612a corresponding to the additional response time deadline 612 is a sub-time period of the timeline 606a corresponding to the response time deadline 606.

As shown in FIG. 6, the card processing system 102 sends the funding request 610 to the external gateway 600. The external gateway 600 receives the funding request 610 and generates an authorization 614 of the electronic card transaction based on transaction data provided to the external gateway with the funding request 610. Additionally, the card processing system 102 also determines dynamic processing parameters 616 for overriding one or more default processing parameters associated with the electronic card transaction based on the transaction data. For instance, as mentioned, the external gateway 600 dynamically determines a transaction-specific interest rate or a transaction-specific reward rate for the electronic card transaction based on the transaction data. As shown, the external gateway 600 generates the authorization 614 and the dynamic processing parameters 616 within the additional response time deadline 612.

In one or more embodiments, as illustrated in FIG. 6, the card processing system 102 and the external gateway 600 authorize the electronic card transaction and determine the dynamic processing parameters 616 within the response time deadline 606. Accordingly, the card processing system 102 provides control over the authorization and processing parameters of the electronic card transaction to the third-party funding source via the external gateway 600 in real-time. More specifically, the card processing system 102 provides real-time, dynamic processing of an electronic card transaction to a third-party funding source that is external to the payment network 602 while meeting a communications requirement of the payment network 602.

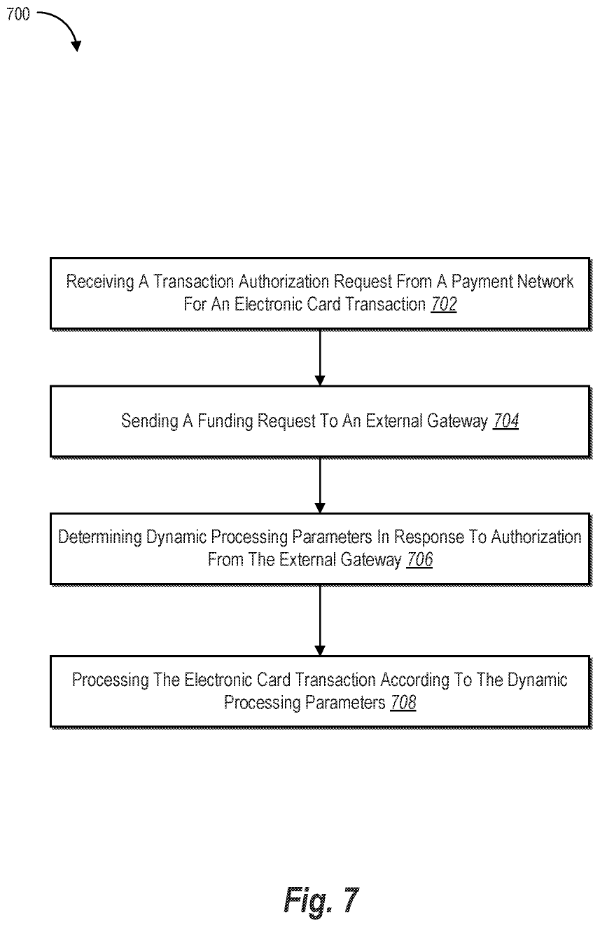

Turning now to FIG. 7, this figure shows a flowchart of a series of acts 700 of determining dynamic processing parameters for an electronic card transaction via an external gateway in real-time. While FIG. 7 illustrates acts according to one embodiment, alternative embodiments may omit, add to, reorder, and/or modify any of the acts shown in FIG. 7. The acts of FIG. 7 can be performed as part of a method. Alternatively, a non-transitory computer readable storage medium can comprise instructions, that when executed by one or more processors, cause a computing device to perform the acts of FIG. 7. In still further embodiments, a system can perform the acts of FIG. 7.

As shown in FIG. 7, the series of acts 700 includes an act 702 of receiving a transaction authorization request from a payment network for an electronic card transaction. For example, act 702 involves receiving, by a card processing system comprising a payment card account funded via an external funding source, a transaction authorization request routed to the card processing system from a payment network in connection with an electronic card transaction.

Act 702 can involve determining, by parsing the transaction authorization request from the payment network, a response time deadline for communicating with the payment network in connection with the transaction authorization request. Specifically, act 702 can involve determining a response time deadline for authorizing the transaction authorization request.

The series of acts 700 also includes an act 704 of sending a funding request to an external gateway. For example, act 704 involves sending, by the card processing system to an external gateway that services the external funding source, a funding request to authorize the transaction authorization request.

Act 704 can involve sending the response indicating the authorization of the funding request to the payment network prior to the response time deadline. For example, act 704 can involve generating the funding request including an additional response time deadline comprising a sub-time period of the response time deadline for the external gateway to respond to the funding request. Act 704 can involve determining an additional response time deadline comprising a sub-time period of the response time deadline according to an estimated amount of time to perform a plurality of computing operations associated with authorizing the electronic card transaction. Act 704 can involve generating the funding request in response to receiving the transaction authorization request from the payment network, the response further indicating the additional response time deadline and the characteristics of the electronic card transaction. Act 704 can also involve receiving the authorization of the funding request from the external gateway within the additional response time deadline, the authorization of the funding request comprising at least one dynamic processing parameter for the electronic card transaction.

Act 704 can involve determining the characteristics of the electronic card transaction based on the transaction authorization request. Act 704 can also involve accessing the parameter ranges corresponding to the payment card account and a stored repayment history of the payment card account from one or more servers of the card processing system in response to receiving the transaction authorization request. Act 704 can involve inserting the characteristics of the electronic card transaction, the parameter ranges corresponding to the payment card account, and the stored repayment history of the payment card account into the funding request to the external gateway.

Act 704 can involve determining, utilizing a first subset of servers of the card processing system, that the electronic card transaction passes a fraud check and velocity controls based on data associated with the electronic card transaction from the transaction authorization request. Act 704 can also involve generating, utilizing a second subset of servers of the card processing system in response to the electronic card transaction passing the fraud check and the velocity controls, the funding request in response to determining that the payment card account has available funding for the electronic card transaction.

Additionally, the series of acts 700 includes an act 706 of determining dynamic processing parameters in response to authorization from the external gateway. For example, act 706 involves determining, by the card processing system in response to an authorization of the funding request from the external gateway, a set of dynamic processing parameters for the electronic card transaction based on characteristics of the electronic card transaction and parameter ranges corresponding to the payment card account. For example, act 706 can involve determining the set of dynamic processing parameters in response to receiving a message comprising the authorization of the funding request from the external gateway and one or more dynamic processing parameters for the electronic card transaction.

Act 706 can involve determining the set of dynamic processing parameters based on an identifier associated with a recipient system associated with the electronic card transaction, a geographic location associated with a client device initiating the electronic card transaction, or a timestamp of the electronic card transaction.

Act 706 can involve determining a set of default processing parameters associated with the electronic card transaction based on a card program associated with the payment card account. Act 706 can involve modifying, in response to the authorization of the funding request from the external gateway, the set of default processing parameters with the set of dynamic processing parameters in metadata associated with the electronic card transaction.

The series of acts 700 also includes an act 708 of processing the electronic card transaction according to the dynamic processing parameters. For example, act 708 involves processing, based on to the card processing system sending a response indicating the authorization of the funding request to the payment network, the electronic card transaction by funding the electronic card transaction from the external funding source according to the set of dynamic processing parameters.

Act 708 can involve determining a transaction-specific interest rate associated with the electronic card transaction. For example, act 708 can involve determining a transaction-specific interest rate associated with the electronic card transaction based on a message from the external gateway comprising the authorization of the funding request. Act 708 can involve generating metadata associated with the electronic card transaction comprising the transaction-specific interest rate. Act 708 can also involve determining a balance of the payment card account for a batch of transactions comprising the electronic card transaction utilizing the transaction-specific interest rate from the metadata associated with the electronic card transaction.

Act 708 can involve overriding a set of default processing parameters for the electronic card transaction within metadata associated with the electronic card transaction in response to determining the set of dynamic processing parameters. Act 708 can involve determining, at one or more servers of the card processing system in connection with processing the electronic card transaction, a balance of the payment card account at a predetermined time based on a batch of transactions comprising the electronic card transaction and metadata for the batch of transactions indicating the set of dynamic processing parameters.

Act 708 can involve determining a transaction-specific reward rate associated with the electronic card transaction. Act 708 can involve generating metadata associated with the electronic card transaction comprising the transaction-specific reward rate. Act 708 can also involve determining a reward balance of the payment card account utilizing the transaction-specific reward rate from the metadata associated with the electronic card transaction. For example, act 708 can involve determining the set of dynamic processing parameters by determining a transaction-specific reward rate associated with the electronic card transaction, and modifying metadata associated with the electronic card transaction by replacing a default reward rate associated with the electronic card transaction with the transaction-specific reward rate.

Act 708 can involve processing the electronic card transaction by determining a balance of the payment card account according to an interest based on the set of dynamic processing parameters and a transaction amount of the electronic card transaction.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 8 illustrates a block diagram of exemplary computing device 800 that may be configured to perform one or more of the processes described above. One will appreciate that one or more computing devices such as the computing device 800 may implement the system(s) of FIG. 1. As shown by FIG. 8, the computing device 800 can comprise a processor 802, a memory 804, a storage device 806, an I/O interface 808, and a communication interface 810, which may be communicatively coupled by way of a communication infrastructure 812. In certain embodiments, the computing device 800 can include fewer or more components than those shown in FIG. 8. Components of the computing device 800 shown in FIG. 8 will now be described in additional detail.

In one or more embodiments, the processor 802 includes hardware for executing instructions, such as those making up a computer program. As an example, and not by way of limitation, to execute instructions for dynamically modifying workflows, the processor 802 may retrieve (or fetch) the instructions from an internal register, an internal cache, the memory 804, or the storage device 806 and decode and execute them. The memory 804 may be a volatile or non-volatile memory used for storing data, metadata, and programs for execution by the processor(s). The storage device 806 includes storage, such as a hard disk, flash disk drive, or other digital storage device, for storing data or instructions for performing the methods described herein.

The I/O interface 808 allows a user to provide input to, receive output from, and otherwise transfer data to and receive data from computing device 800. The I/O interface 808 may include a mouse, a keypad or a keyboard, a touch screen, a camera, an optical scanner, network interface, modem, other known I/O devices or a combination of such I/O interfaces. The I/O interface 808 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 808 is configured to provide graphical data to a display for presentation to a user. The graphical data may be representative of one or more graphical user interfaces and/or any other graphical content as may serve a particular implementation.

The communication interface 810 can include hardware, software, or both. In any event, the communication interface 810 can provide one or more interfaces for communication (such as, for example, packet-based communication) between the computing device 800 and one or more other computing devices or networks. As an example, and not by way of limitation, the communication interface 810 may include a network interface controller (NIC) or network adapter for communicating with an Ethernet or other wire-based network or a wireless NIC (WNIC) or wireless adapter for communicating with a wireless network, such as a WI-FI.

Additionally, the communication interface 810 may facilitate communications with various types of wired or wireless networks. The communication interface 810 may also facilitate communications using various communication protocols. The communication infrastructure 812 may also include hardware, software, or both that couples components of the computing device 800 to each other. For example, the communication interface 810 may use one or more networks and/or protocols to enable a plurality of computing devices connected by a particular infrastructure to communicate with each other to perform one or more aspects of the processes described herein. To illustrate, the digital content campaign management process can allow a plurality of devices (e.g., a client device and server devices) to exchange information using various communication networks and protocols for sharing information such as electronic messages, user interaction information, engagement metrics, or campaign management resources.

In the foregoing specification, the present disclosure has been described with reference to specific exemplary embodiments thereof. Various embodiments and aspects of the present disclosure(s) are described with reference to details discussed herein, and the accompanying drawings illustrate the various embodiments. The description above and drawings are illustrative of the disclosure and are not to be construed as limiting the disclosure. Numerous specific details are described to provide a thorough understanding of various embodiments of the present disclosure.

The present disclosure may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

What is claimed is:

1. A computer-implemented method comprising:
receiving, by one or more servers of a card processing system comprising a payment card account funded via an external funding source, a transaction authorization request routed to the card processing system from a payment network in connection with an electronic card transaction;
sending, by the one or more servers of the card processing system to an external gateway that services the external funding source, a funding request to authorize the transaction authorization request;
determining, by the one or more servers of the card processing system in response to an authorization of the funding request from the external gateway, a set of dynamic processing parameters for the electronic card transaction based on characteristics of the electronic card transaction and parameter ranges corresponding to the payment card account; and
processing, based on the one or more servers of the card processing system sending a response indicating the authorization of the funding request to the payment network, the electronic card transaction by funding the electronic card transaction from the external funding source according to the set of dynamic processing parameters.

2. The computer-implemented method of claim 1, wherein:
receiving the transaction authorization request comprises determining, by parsing the transaction authorization request from the payment network, a response time deadline for communicating with the payment network in connection with the transaction authorization request; and
sending the funding request comprises generating the funding request including an additional response time deadline comprising a sub-time period of the response time deadline for the external gateway to respond to the funding request.

3. The computer-implemented method of claim 2, further comprising:
generating the funding request in response to receiving the transaction authorization request from the payment network, the response further indicating the additional response time deadline and the characteristics of the electronic card transaction; and
receiving the authorization of the funding request from the external gateway within the additional response time deadline, the authorization of the funding request comprising at least one dynamic processing parameter for the electronic card transaction.

4. The computer-implemented method of claim 1, wherein determining the set of dynamic processing parameters comprises determining a transaction-specific interest rate associated with the electronic card transaction.

5. The computer-implemented method of claim 4, wherein processing the electronic card transaction comprises:
generating metadata associated with the electronic card transaction comprising the transaction-specific interest rate; and
determining a balance of the payment card account for a batch of transactions comprising the electronic card transaction utilizing the transaction-specific interest rate from the metadata associated with the electronic card transaction.

6. The computer-implemented method of claim 1, wherein determining the set of dynamic processing parameters comprises determining a transaction-specific reward rate associated with the electronic card transaction.

7. The computer-implemented method of claim 6, wherein processing the electronic card transaction comprises:
generating metadata associated with the electronic card transaction comprising the transaction-specific reward rate; and
determining a reward balance of the payment card account utilizing the transaction-specific reward rate from the metadata associated with the electronic card transaction.

8. The computer-implemented method of claim 1, wherein sending the funding request comprises:
determining, utilizing a first subset of servers of the card processing system, that the electronic card transaction passes a fraud check and velocity controls based on data associated with the electronic card transaction from the transaction authorization request; and
generating, utilizing a second subset of servers of the card processing system in response to the electronic card transaction passing the fraud check and the velocity controls, the funding request in response to determining that the payment card account has available funding for the electronic card transaction.

9. The computer-implemented method of claim 1, wherein determining the set of dynamic processing parameters comprises determining the set of dynamic processing parameters based on an identifier associated with a recipient system associated with the electronic card transaction, a geographic location associated with a client device initiating the electronic card transaction, or a timestamp of the electronic card transaction.

10. The computer-implemented method of claim 1, wherein determining the set of dynamic processing parameters comprises:
determining a set of default processing parameters associated with the electronic card transaction based on a card program associated with the payment card account; and
modifying, in response to the authorization of the funding request from the external gateway, the set of default processing parameters with the set of dynamic processing parameters in metadata associated with the electronic card transaction.

11. A system comprising:
at least one processor; and
a non-transitory computer readable medium comprising instructions that, when executed by the at least one processor, cause the system to:
receive, by a card processing system comprising a payment card account funded via an external funding source, a transaction authorization request routed to the card processing system from a payment network in connection with an electronic card transaction;
send, by the card processing system to an external gateway that services the external funding source, a funding request to authorize the transaction authorization request;
determine, by the card processing system in response to an authorization of the funding request from the external gateway, a set of dynamic processing parameters for the electronic card transaction based on characteristics of the electronic card transaction and parameter ranges corresponding to the payment card account; and
process, based on to the card processing system sending a response indicating the authorization of the funding request to the payment network, the electronic card transaction by funding the electronic card transaction from the external funding source according to the set of dynamic processing parameters.

12. The system of claim 11, further comprising instructions that, when executed by the at least one processor, cause the system to:
determine, by parsing the transaction authorization request from the payment network, a response time deadline for authorizing the transaction authorization request; and
send the response indicating the authorization of the funding request to the payment network prior to the response time deadline.

13. The system of claim 12, further comprising instructions that, when executed by the at least one processor, cause the system to:
determine an additional response time deadline comprising a sub-time period of the response time deadline according to an estimated amount of time to perform a plurality of computing operations associated with authorizing the electronic card transaction; and
sending the funding request with the additional response time deadline to the external gateway to authorize the transaction authorization request.

14. The system of claim 11, further comprising instructions that, when executed by the at least one processor, cause the system to, determine the set of dynamic processing parameters by determining a transaction-specific interest rate associated with the electronic card transaction based on a message from the external gateway comprising the authorization of the funding request.

15. The system of claim 14, further comprising instructions that, when executed by the at least one processor, cause the system to:
override a set of default processing parameters for the electronic card transaction within metadata associated with the electronic card transaction in response to determining the set of dynamic processing parameters; and
determine, at one or more servers of the card processing system in connection with processing the electronic card transaction, a balance of the payment card account at a predetermined time based on a batch of transactions comprising the electronic card transaction and metadata for the batch of transactions indicating the set of dynamic processing parameters.

16. The system of claim 11, further comprising instructions that, when executed by the at least one processor, cause the system to:
determine the set of dynamic processing parameters by:
determining a transaction-specific reward rate associated with the electronic card transaction; and
modifying metadata associated with the electronic card transaction by replacing a default reward rate associated with the electronic card transaction with the transaction-specific reward rate; and
modify, at one or more servers of the card processing system in connection with processing the electronic card transaction, a reward balance of the payment card account utilizing the transaction-specific reward rate from the metadata associated with the electronic card transaction.

17. A non-transitory computer readable medium comprising instructions that, when executed by at least one processor, cause a computing device to:
receive, by a card processing system comprising a payment card account funded via an external funding source, a transaction authorization request routed to the card processing system from a payment network in connection with an electronic card transaction;
send, by the card processing system to an external gateway that services the external funding source, a funding request to authorize the transaction authorization request;
determine, by the card processing system in response to an authorization of the funding request from the external gateway, a set of dynamic processing parameters for the electronic card transaction based on characteristics of the electronic card transaction and parameter ranges corresponding to the payment card account; and
process, based on the card processing system sending a response indicating the authorization of the funding request to the payment network, the electronic card transaction by funding the electronic card transaction from the external funding source according to the set of dynamic processing parameters.

18. The non-transitory computer readable medium of claim 17, further comprising instructions that, when executed by the at least one processor, cause the computing device to:
determine, by parsing the transaction authorization request from the payment network, a response time deadline for communicating with the payment network in connection with the transaction authorization request;
send the funding request to the external gateway with an additional response time deadline comprising a sub-time period of the response time deadline; and
determine the set of dynamic processing parameters in response to receiving a message comprising the authorization of the funding request from the external gateway and one or more dynamic processing parameters for the electronic card transaction.

19. The non-transitory computer readable medium of claim 17, further comprising instructions that, when executed by the at least one processor, cause the computing device to:
determine the characteristics of the electronic card transaction based on the transaction authorization request;
access the parameter ranges corresponding to the payment card account and a stored repayment history of the payment card account from one or more servers of the card processing system in response to receiving the transaction authorization request; and
insert the characteristics of the electronic card transaction, the parameter ranges corresponding to the payment card account, and the stored repayment history of the payment card account into the funding request to the external gateway.

20. The non-transitory computer readable medium of claim 17, further comprising instructions that, when executed by the at least one processor, cause the computing device to process the electronic card transaction by determining a balance of the payment card account according to an interest based on the set of dynamic processing parameters and a transaction amount of the electronic card transaction.
